(19) United States
(12) Patent Application Publication
(10) Pub. No.: US 2006/0005485 A1
(43) Pub. Date: Jan. 12, 2006

(54) Remotely controlled service window

(76) Inventors: Jim C. Epps, Houston, TX (US); Jack Weaver, Cypress, TX (US); Dan Terry, Houston, TX (US)

Correspondence Address: TROP PRUNER & HU, PC, 8554 KATY FREEWAY, SUITE 100, HOUSTON, TX, 77024, US

(21) Appl. No.: 11/225,669

(22) Filed: Sep. 13, 2005

Related U.S. Application Data
(63) Continuation-in-part of application No. 10/144,599, filed on May 13, 2002.
(60) Provisional application No. 60/292,554, filed on May 22, 2001.

(51) Int. Cl. E06B 3/32

(52) U.S. Cl. 52/204.51

(57) ABSTRACT

A service window may be operated under hands free user remote control. For example, a service window of the type used in fast-food restaurants, may be opened or closed in response to remote control signals.

### CROSS-REFERENCE TO RELATED APPLICATION

This application is a continuation-in-part of U.S. application Ser. No. 10/144,599, filed May 13, 2002, which was based on provisional Application Ser. No. 60/292,554, filed May 22, 2001.

### BACKGROUND

This invention pertains to service windows and, more particularly, to service windows for drive-thru and walk-up fast food service installations. These service windows are typically provided in a building, such as a fast-food service establishment, a convenience drive-up food store, a service station attendant's booth, a free-standing kiosk, or the like.

Service windows are typically installed on the side of a building adjacent a driveway or sidewalk to facilitate business transactions between an employee and a customer. Such windows conventionally permit an employee to view a customer approaching the window and to personally transact business with the customer. In a typical commercial environment, a drive-up service window permits the employee to transact business with a customer and yet provides the necessary isolation between the outside environment and the inside environment to satisfy health and safety requirements.

In some cases, the service window may be operated by the employee while the employee is holding products to be passed through the service window. As a result, the employee's hands may not be free to operate various window mechanisms or operators. Thus, automatic detectors have been provided in association with service windows to automatically open the windows at the appropriate time. For example, detectors such as optical or infrared detectors may detect the presence of the employee proximate to the window and may automatically open the window.

However, existing automatic windows may be prone to inadvertent operation. For example, anytime the employee stands too close to the window, the window may open. This may be disadvantageous, particularly where climatic conditions are adverse. In addition, excessive window opening in a restaurant environment may raise some health issues.

Thus, there is a need for better ways to operate service windows.

### BRIEF DESCRIPTION OF THE DRAWINGS

FIG. 1 is a perspective view of a service window in accordance with one embodiment of the present invention;

FIG. 2 is a partial perspective of a part of the window shown in FIG. 1 according to one embodiment of the present invention;

FIG. 3 is a schematic depiction of one embodiment of the present invention;

FIG. 4 is a schematic depiction of a service window in use in accordance with one embodiment of the present invention;

FIG. 5 is a flow chart, useful in accordance with one embodiment of the present invention;

FIG. 6 is a flow chart, useful in accordance with another embodiment of the present invention;

FIG. 7 is a flow chart, useful in accordance with still another embodiment of the present invention;

FIG. 8 is a schematic depiction of another embodiment; and

FIG. 9 is a front elevational view of one embodiment of a remote window controller worn by a service employee.

### DETAILED DESCRIPTION

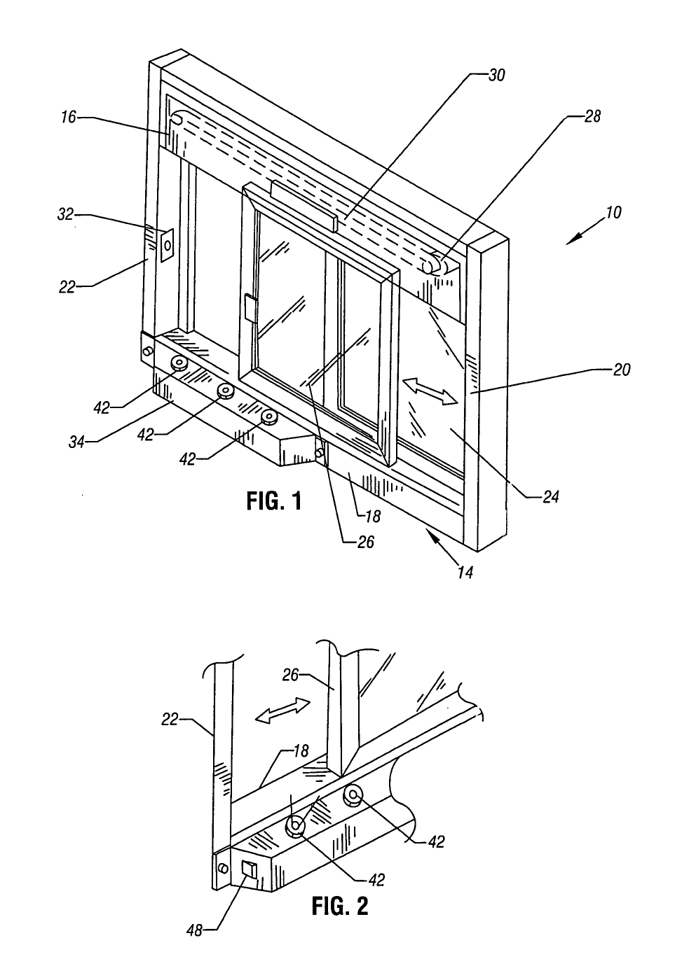

In one embodiment of the present invention, shown in FIG. 1, a service window 10 has a frame 14 including a top cross piece 16 and a bottom cross piece 18. Two side pieces 20, 22 connect the top cross piece 16 and the bottom cross piece 18. A fixed window pane 24 may be provided within the frame 14 in one embodiment. A sliding window pane 26 moves between open and closed positions, thereby opening or closing the window 10. An electric motor 28 may drive a linkage 30 connected to the sliding pane 26. The linkage 30 moves the sliding window pane 26 in response to the action of the electric motor 28.

Those skilled in the art will recognize that although a sliding window is illustrated, other automatic window configurations may also be used, such as folding, biparting, or swinging windows. Also, while a window 10 with only one moving glass panel is shown in FIG. 1, in other embodiments there may be more than one moving glass panel. In addition, while a motorized window is illustrated, in other embodiments audible commands may be used to trigger operation of non-motorized windows, including those with mechanical operators.

A microphone 32 may detect sound or vocal commands. A sound recognition module 34 identifies an audible command to open or close the window 10. For example, the module 34 may generate a signal that controls the motor 28. The module 34 may be located any where on the window 10 or remotely therefrom.

The module 34 advantageously distinguishes between the voice of the employee using the window 10 and background noise from within the service establishment in one embodiment of the present invention. A particular word or phrase may be selected in some embodiments to activate the window 10. In other embodiments, a distinct non-vocal sound may be used to trigger the module 34.

The microphone 32 may be mounted on the window 10, for example on a side piece 22, or at another location, remote from the window 10. A remote microphone 32 may be coupled by a wired or wireless connection to the module 34. The microphone 32 may be associated with the employee, for example, via a headset microphone or a lapel microphone, as two examples of remote microphones.

The module 34 may be used alone or in connection with other apparatus for controlling the service window 10. For example, proximity sensors 42 may be used to detect the presence of an employee reaching towards the service window 10. Upwardly, outwardly, or downwardly directed proximity sensors 42 may be used. The control module 34 may receive a signal from a sensor 42 indicating that the employee is adjacent the window 10 in one embodiment. Proximity sensors may be light beams, infrared beams, pattern detecting cameras, or switches, to mention a few examples.

The proximity sensors 42 may be used for connection with an automatic closure mechanism in one embodiment of the present invention. After opening the window, a timer may start. After a time out, the window 10 may be automatically closed unless proximity is detected by the sensor 42.

Activation of a manual control switch 48, shown in FIG. 2, may override signals from other sensors, including the module 34. In this way, the window 10 may still be operated open or closed even if conditions, such as background noise, interfere with other control apparatus.

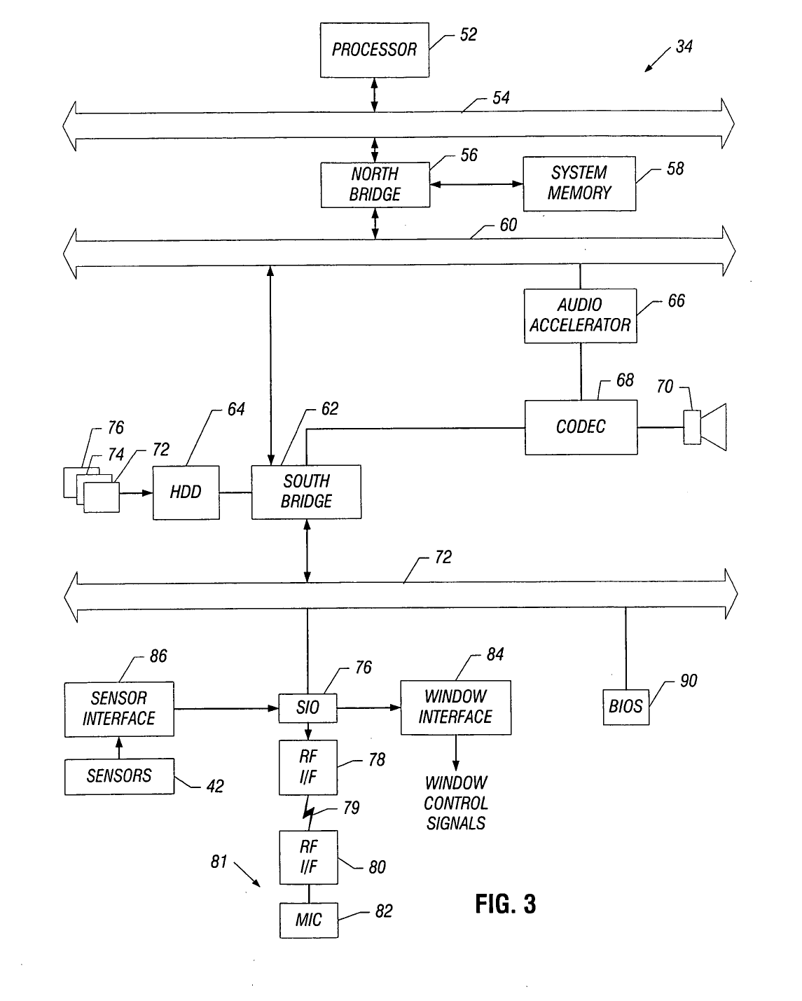

One embodiment of a processor-based module 34 for implementing the capabilities described herein, shown in FIG. 3, may include a processor 52 that communicates across a host bus 54 to a bridge 56 and system memory 58. The bridge 56 may communicate with a bus 60 which could, for example, be a Peripheral Component Interconnect (PCI) bus in accordance with Revision 2.1 of the PCI Electrical Specification available from the PCI Special Interest Group, Portland, Oreg. 97214.

A microphone 32 input signal may be provided to the audio codec (AC'97) 68 where it may be digitized and sent to memory through an audio accelerator 66. The AC'97 specification is available from Intel Corporation, Santa Clara, Calif. Sound data generated by the processor 52 may be sent to the audio accelerator 66 and the AC'97 codec 68 and on to the speaker 70.

In some embodiments of the present invention, a microphone 82 may be provided in a remote control unit 81 which is used to operate the module 34. The remote control unit 81 may be attached to the employee via a lapel microphone or headset, as two examples. For example, the microphone input may be transmitted through a wireless interface 79 to the module 34 and its wireless interface 78 in one embodiment of the present invention.

The bus 72 may be coupled to a bus bridge 62 that may couple to a hard disk drive 64. The bridge 62 may in turn be coupled to an additional bus 72, which may couple to a serial interface 76 which drives a wireless interface 78. The interface 78 may communicate with the remote control unit 81. A basic input/output system (BIOS) memory 90 may also be coupled to the bus 72. The interface 78 may communicate with the remote control unit 81.

The serial interface 76 may also receive a signal from a sensor interface 86 that is coupled to proximity sensors 42. In addition, the serial interface 76 may provide an output signal to the window interface 84 which provides window control signals to the motor 28 to operate the window 10. A hard disk drive 64 or other storage device may store a plurality of software programs 72, 74, and 76. In some embodiments, the processor 52 may provide a timer function so that, after a window 10 is opened, a timer begins. After a set time out, the window may be automatically closed. However, if the sensors 42 provide a signal to the sensor interface 86, the window may be maintained open because the employee may be using the opened window.

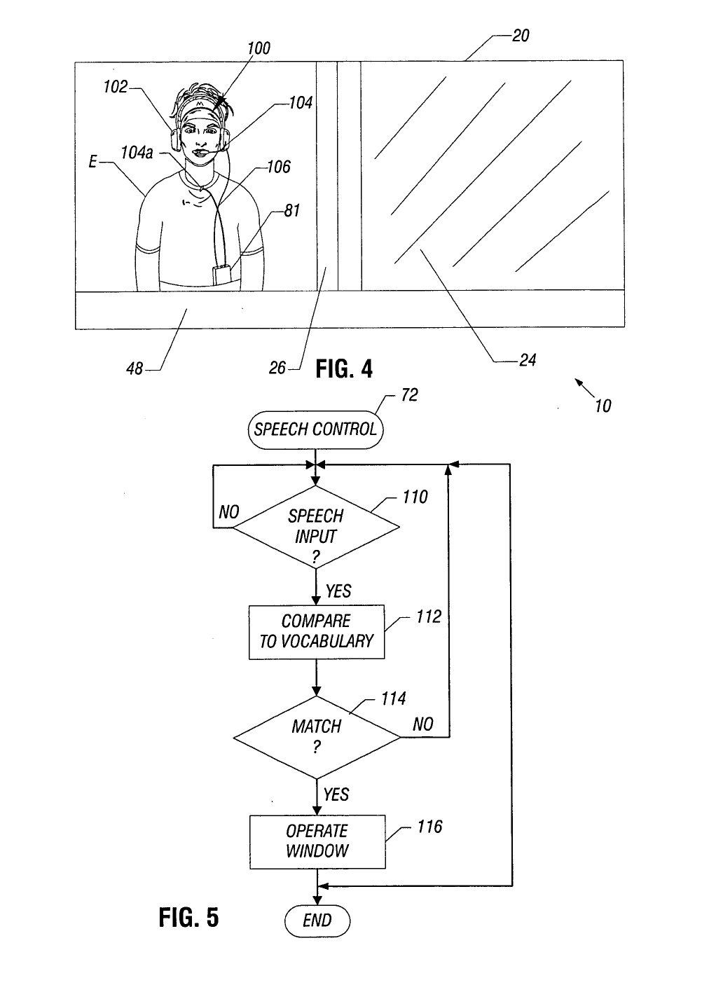

Referring to FIG. 4, the employee E may, in one embodiment of the present invention, wear a headset 100. The headset 100 may include a microphone 104, which in one mode may be used to communicate with the customer outside of the retail facility. The headset 100 may include earphones 102 to listen to feedback from the customer. A lapel microphone 104a may be provided in some embodiments. The headset 100 and/or the lapel microphone 104a may communicate with a battery powered wireless interface 81.

The interface 81 may communicate with the module 34 using a wireless link 79. The wireless link 79 may be infrared based, in one embodiment, or based on radio frequency, as another example. Thus, the employee may interact with a customer outside of the window 10 when the pane 24 is in the open position. In some embodiments, the module 34 may be wirelessly coupled to the window 10.

Referring to FIG. 5, in accordance with one embodiment of the present invention, the window 10 may be controlled in response to spoken commands from the employee. Thus, a check at diamond 110 determines whether or not a speech input has been received. If so, the spoken word is compared to a vocabulary, as indicated in block 112. In some embodiments the vocabulary may be relatively limited. For example, very simple commands may be recognized, such as “open” or “close.” In other embodiments more extensive vocabularies may be available. For example, a conversational speech system may be implemented which understands a large variety of terms and devines the meaning of the spoken phases in order to control the window 10.

A check at diamond 114 determines whether there is a match between the received input and the vocabulary. If so, the window may be operated, as indicated in block 116, consistent with the received command.

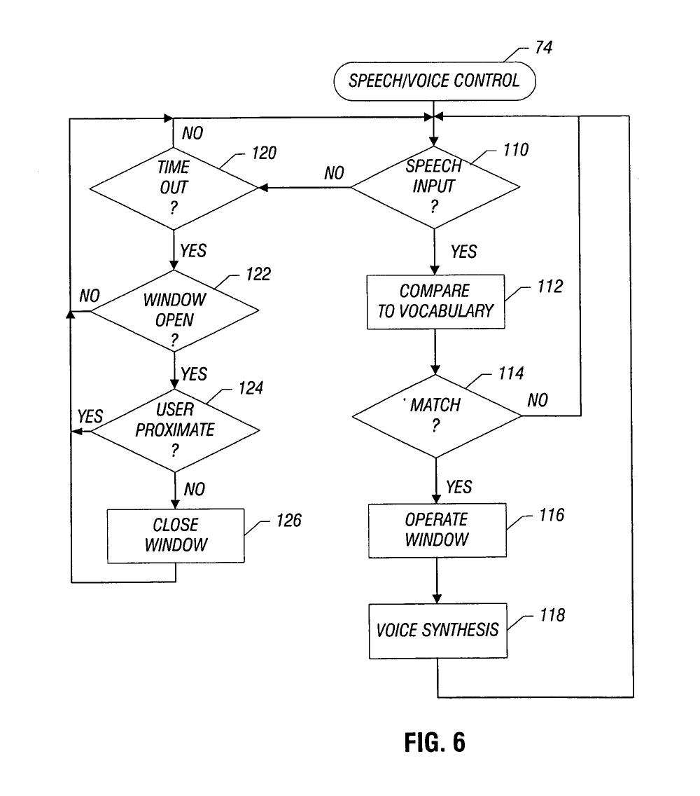

Referring to FIG. 6, in accordance with another embodiment of the present invention, the speech/voice control software 74 detects a speech input as indicated at diamond 110. If no speech input has been received, a check at diamond 120 determines whether a time out has occurred. If so, a check at diamond 122 determines whether the window 10 is open. If it is, a check at diamond 124 determines whether the employee is proximate. This may be done based on inputs from the sensors 42. If the employee is not proximate, the window 10 may be closed as indicated in block 126. As a result, once the window 10 has been opened in response to a spoken command, it may be automatically closed after the expiration of a time out period unless, in some embodiments, the employee is proximate to the window.

If a speech input has been received at diamond 110 and the vocabulary is checked at block 112. The presence of a match is determined at diamond 114 and the window is operated at 116, if appropriate.

At block 118, voice synthesis may be provided in some embodiments. For example, in some embodiments, it may be desirable to automatically synthesize a statement to the customer as soon as the window opens, such as a welcoming statement or other automated statement that otherwise, necessarily, would be spoken by the employee. This enables the employee to continue to do other tasks while introductory phrases (or other phrases) may be automatically generated by the system. For example, the system may welcome the customer and ask for the customer's order. Only when the order is actually being taken, in some embodiments, need the employee actually begin working with the customer. In some cases the employee may face the customer at all times while still continuing to undertake other duties.

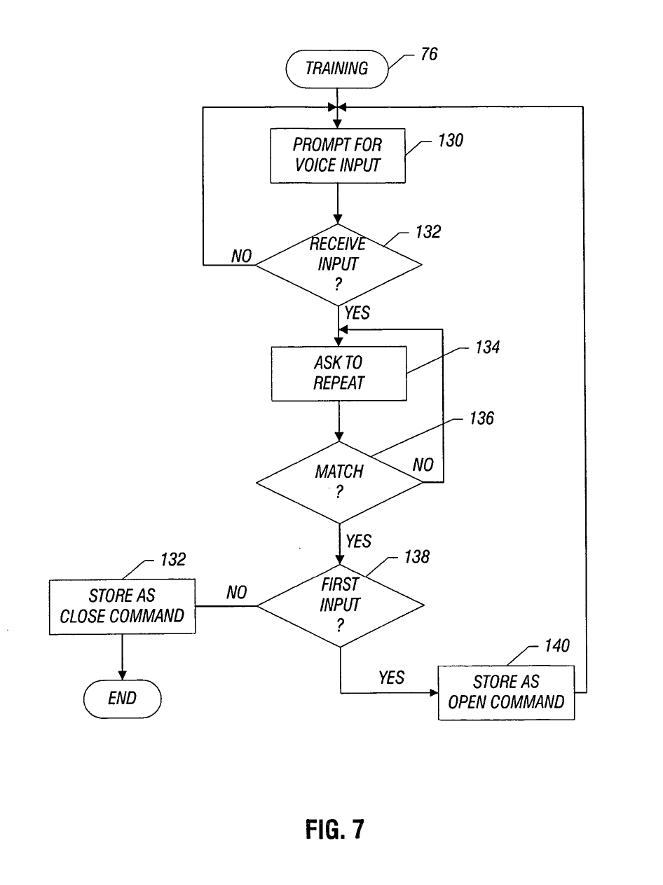

Referring to FIG. 7, training software 76 in accordance with one embodiment of the present invention initially prompts the employee for a voice input as indicated at block 130. The prompt may be on a computer display screen or may be audibly generated as two examples. In response to the prompt, a check at diamond 132 determines whether an input is received from the employee. The input may typically be the command that the employee wishes to speak in order to cause the window 10 to open. Once the input is received, the employee may be asked to repeat the spoken command at block 134 to ensure that a good signal was received. A check at diamond 136 determines whether the first and second spoken commands match sufficiently that a good result may be obtained.

A check at diamond 138 determines whether or not the employee has previously provided another command. If this is not the first input then the command that was just received is stored as a close window command as indicated in block 132. Otherwise, the command is stored as an open command and the flow recycles to receive the close command.

In some embodiments, training the system to recognize the actual employee's voice may reduce errors. That is because the employee can provide actual samples of his voice, the system need not recognize spoken commands from a wide variety of different people. This may improve the accuracy of the system and make it more user friendly to some users who can provide any word they wish for the open and close commands.

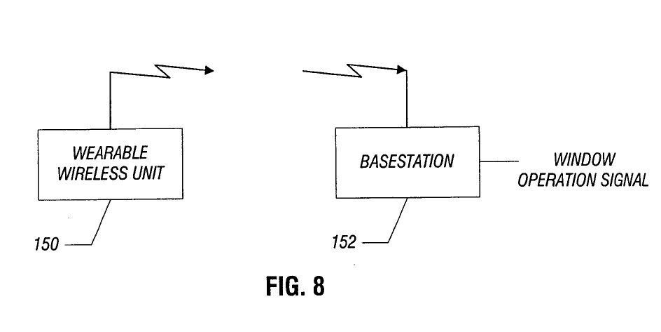

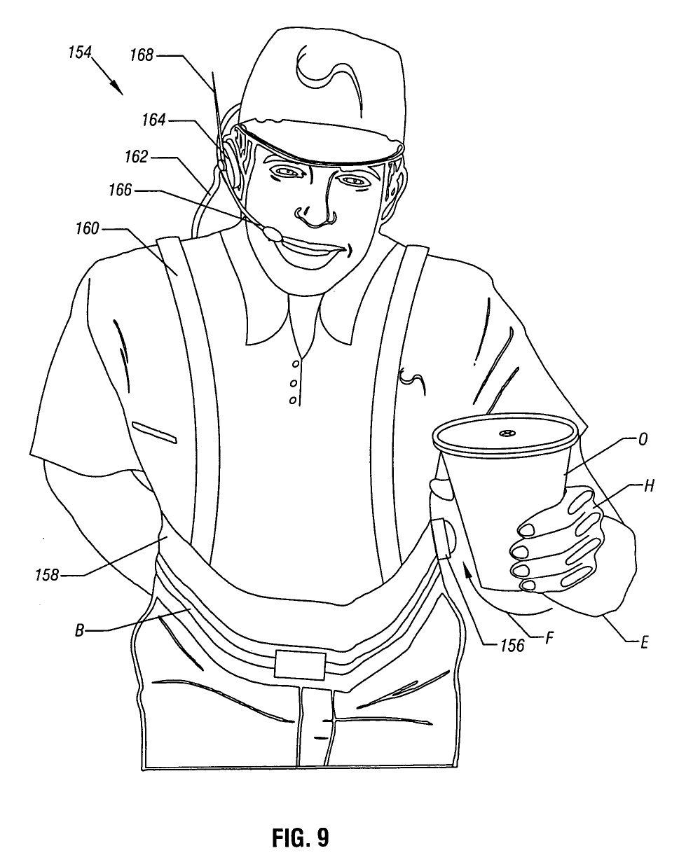

Referring now to FIG. 8, a wirelessly and remotely controllable base station 152 may receive control signals from a wearable wireless unit 150. The wearable wireless 150 may be worn by a service employee. The service employee may operate the wearable wireless unit 150 to send wireless signals to the base station 152. In some embodiments, the wireless signals may be sent by radio frequency or infrared signals. For example, the wearable wireless unit may initiate radio frequency signals in accordance with the Bluetooth standard as one embodiment. In some embodiments, the base station may be intimately associated with the window 10 so as to operate a motor associated therewith. In other words, the base station may be implemented as part of the window interface 84 in one embodiment of the present invention.

Referring to FIG. 9, in accordance with one embodiment of the present invention, a service employee may wear a headset 154. The headset 154 may include an earphone 164 to hear signals provided from a remote drive through station by customers. For example, in connection with a drive-up station, the customer may speak into a microphone and the signal may be transmitted to the headset 154 to be heard through the earphone 164. To this end, a wireless antenna 168 may be included. The wireless antenna may communicate by a wire 162 with a battery pack and transceiver (not shown) but attached to a belt 158.

Also connected to the headset 154 may be a microphone 166, into which the employee may talk and signals may be generated to be wirelessly transmitted to a customer.

The employee may wear a harness including shoulder straps 162 and a chest encircling strap 158. Mounted on the strap 158, in a position to be actuated by the internal surfaces of the employee's elbow E, is a push button 156. Namely, when the employee rotates his elbow inwardly in the direction indicated by the arrows F, the button 156 may be operated to either open or close the window 10. In one embodiment, if the window is closed, when the button 156 is operated the window opens and, if the window is open, when the button 156 is operated, the window closes.

In some embodiments, the belt 158 may be worn higher than the normal clothing belt B so that it is in line to be operated by the service employee's elbow E.

As a result, the employee may have his hands filled, for example, holding a cup 0 in his hand H, and still may be able to remotely open and close the service window 10.

When the push button 156 is operated, a signal is transmitted through conductors (not shown) to the transceiver (not shown) and on to the headset 154, which sends a signal wirelessly over the antenna 168 to a base station 152 associated with the window 10 in one embodiment. In another embodiment, a transmitter (not shown) may directly transmit the window control signal without involving the headset 154. The base station 152 may include the interface 84 which generates motor control signals to operate the service window 10.

While an embodiment is depicted in which a push button operator 156 is positioned on the employee's side at a position raised with respect to the belt B, those skilled in the art will appreciate other embodiments. However, it may be particularly advantageous, in some embodiments, to enable hands free operation of the window and to enable remote operation of the window.

One reason that remote operation may be desirable is that it can save time. Instead of requiring the employee to approach the window and then operate the window, consuming additional time, the service employee may operate the window in route to a position proximate to the service window 10 so that, by the time the employee arrives, the window is already fully open.

Given the very large number of service operations and the desire to maintain the service window 10 in the closed position when not in use, the time savings may be significant. These time savings may also result in better service to customers.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a service window; and
enabling said window to be operated in response to a remote control device operable without using the user's hands.

2. The method of claim 1 including automatically determining when a user is proximate to said window.

3. The method of claim 2 including automatically closing said window after a period of time.

4. The method of claim 3 including maintaining said window open after the period of time if a user is proximate to said window.

5. The method of claim 1 including generating a wireless signal from a wearable wireless unit and transmitting said signal to a base station positioned to operate said window.

6. The method of claim 5 including providing a harness mounted button to operate the window.

7. The method of claim 6 including providing said button on a wearable harness operable without use of the hands.

8. The method of claim 7 including enabling a radio frequency signal to be generated to operate said window.

9. The method of claim 8 including providing a wireless headset to receive audible customer orders and enabling said headset to also transmit window control signals.

10. A service window comprising:
a frame;
a window movable in said frame;
a wireless remote control to enable said window to be remotely operated hands free without physically touching the window.

11. The window of claim 10 wherein said wireless remote control uses radio frequency waves.

12. The window of claim 10 wherein said wireless remote control uses infrared energy.

13. The window of claim 10 wherein said wireless interface is adapted to be wearable by an operator.

14. The window of claim 13 wherein said apparatus may be worn as a belt.

15. The window of claim 10 wherein said wireless remote control is sound responsive.

16. The window of claim 10 wherein said belt may include a push operator.

17. The window of claim 16 wherein said push operator is elbow operable.

18. The window of claim 17 wherein said belt is wearable above the waist so as to align with an elbow.

19. A wearable unit for a service employee comprising:
a wireless headset to receive audible customer orders and to transmit wireless signals to control a service window; and
a harness including a belt carrying a pushbutton operator operable without using the operator's hands to open a service window.

20. The unit of claim 19 wherein said pushbutton is wearable on the employee's side above belt level.
